(19) United States
(12) Patent Application Publication
(10) Pub. No.: US 2014/0149600 A1
(43) Pub. Date: May 29, 2014

(54) METHOD FOR HANDLING MULTIPLE REQUESTS BY USING DATASET TRANSFER PROTOCOL

(71) Applicant: TOBESOFT CO., LTD., Seoul (KR)

(72) Inventor: Jaeoh Park, Gwangju-si (KR)

(73) Assignee: TOBESOFT CO., LTD., Seoul (KR)

(21) Appl. No.: 14/065,632

(22) Filed: Oct. 29, 2013

(30) Foreign Application Priority Data
Nov. 29, 2012 (KR) 10-2012-0136969

(51) Int. Cl. H04L 29/06

(52) U.S. Cl. CPC H04L 29/06
USPC 709/232

(57) ABSTRACT

A method for processing multiple requests using a dataset transfer protocol is disclosed. The method includes generating a dataset transfer protocol and transmitting the dataset transfer protocol to a Web Application Server (WAS) by a client. The dataset transfer protocol includes at least one contract dataset including information about a sequence number of a contract generated according to a processing request and information about a requested task, at least one reference dataset referred to for processing the processing request, at least one datamap dataset including type information indicating a type of the reference dataset referred to in relation to the contract and mapping information about the reference dataset, and at least one header including information about a name of the contract dataset and information about a name of the mapping information dataset.

### CROSS REFERENCE TO RELATED APPLICATIONS

This application claims the benefit of Korean Patent Application No. 10-2012-0136969, filed on Nov. 29, 2012, which is hereby incorporated by reference as if fully set forth herein.

### BACKGROUND OF THE INVENTION

1. Field of the Invention

The present invention relates to a method for processing multiple requests using a dataset transfer protocol, and more particularly, to a method for processing multiple requests using a dataset transfer protocol, in which when a client calls a plurality of services, the services can be processed by one invocation.

2. Discussion of the Related Art

For an on-line service, a client communicates with a Web application server (WAS). FIG. 1 illustrates a configuration of a system, referred to for describing a conventional client-WAS communication method. A client 110 can reply to one type of request with one response only at one time in a system. Accordingly, regarding a plurality of requests, the client 110 should process the requests in parallel or sequentially.

In this case, the client should be connected to the WAS for the requests one by one. As a result, a session connection is established per request and many resources are used, thus imposing a great constraint on the client. Moreover, redundant session connections and request packets lead to a bandwidth loss in a network.

### SUMMARY OF THE INVENTION

Accordingly, the present invention is directed to a method for processing multiple requests using a dataset transfer protocol that substantially obviates one or more problems due to limitations and disadvantages of the related art.

An object of the present invention is to provide a method for processing multiple requests using a dataset transfer protocol, in which a client transmits a plurality of process requests at one time using a dataset transfer protocol defined between the client and a server so that the process requests may be processed at one time.

Additional advantages, objects, and features of the invention will be set forth in part in the description which follows and in part will become apparent to those having ordinary skill in the art upon examination of the following or may be learned from practice of the invention. The objectives and other advantages of the invention may be realized and attained by the structure particularly pointed out in the written description and claims hereof as well as the appended drawings.

To achieve these objects and other advantages and in accordance with the purpose of the invention, as embodied and broadly described herein, a method for processing multiple requests using a dataset transfer protocol includes generating a dataset transfer protocol and transmitting the dataset transfer protocol to a Web Application Server (WAS) by a client. The dataset transfer protocol includes at least one contract dataset including information about a sequence number of a contract generated according to a processing request and information about a requested task, at least one reference dataset referred to for processing the processing request, at least one datamap dataset including type information indicating a type of the reference dataset referred to in relation to the contract and mapping information about the reference dataset, and at least one header including information about a name of the contract dataset and information about a name of the mapping information dataset.

The contract dataset may further include level information indicating a level at which the contract is positioned in a tree structure and information about a sequence number of a parent contract for the contract.

The datamap dataset may include information about a sequence number of a reference contract, information about a name of the reference dataset defined by the client, information about a name of a dataset mapped to a dataset corresponding to the name information about the reference dataset in an called service, and information about a name of a dataset to store a result of the requested task.

The reference dataset may include at least one of an input dataset, an output dataset, and a header dataset specifying additional information required for the processing request.

The type information may indicate at least one of the input dataset, the output dataset, and the header dataset.

The header may be a HyperText Transfer Protocol (HTTP) header.

It is to be understood that both the foregoing general description and the following detailed description of the present invention are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this application, illustrate embodiment(s) of the invention and together with the description serve to explain the principle of the invention. In the drawings:

FIG. 1 illustrates a system configuration referred to for describing a conventional client-Web Application Server (WAS) communication method;

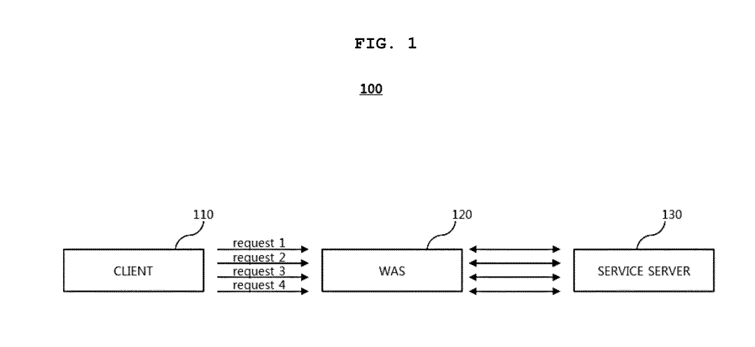

FIG. 2 illustrates a system configuration referred to for describing a method for processing multiple requests using a Dataset Transfer Protocol (DTP) according to an embodiment of the present invention;

FIG. 3 illustrates a structure of the DTP in the method for processing multiple requests using a DTP according to the embodiment of the present invention;

FIG. 4 illustrates information included in the DTP, which is represented as a function, in the method for processing multiple requests using a DTP according to the embodiment of the present invention; and

FIG. 5 illustrates an exemplary structure of the DTP in the method for processing multiple requests using a DTP according to the embodiment of the present invention.

### DETAILED DESCRIPTION OF THE INVENTION

The objectives and effects of the present invention and the technical configurations of the present invention to achieve them will be apparent with reference to embodiments of the present invention described in detail with the attached drawings. A detailed description of a generally known function and structure of the present invention will be avoided lest it should obscure the subject matter of the present invention. Although the terms used in the present invention are selected from generally known and used terms, taking into account the structures, roles, and functions of the present invention, they are subject to change depending on the intention of a user or an operator or practices.

It is to be clearly understood that the present invention may be implemented in various manners, not limited to embodiments as set forth herein. The embodiments of the present invention are provided only to render the disclosure of the present invention comprehensive and indicate the scope of the present invention to those skilled in the art. The present invention is defined only by the appended claims. Accordingly, the scope of the invention should be determined by the overall description of the specification.

Through the specification, when it is said that some part “includes” a specific element, this means that the part may further include other elements, not excluding them, unless otherwise mentioned.

Here, it can be appreciated that respective blocks of the processing flowcharts and the combinations of the flowcharts can be executed using computer program instructions. Since these computer program instructions may be installed in the processor of a multipurpose computer, a special computer or some other programmable data processing equipment, means tar performing functions described in one or more flowchart blocks are created using the instructions that are executed using the processor of a computer or some other programmable data processing equipment. These computer program instructions may be stored in a computer-usable or computer-readable memory which is oriented to a computer or some other programmable data processing equipment in order to implement functions in a specific manner. Moreover, since these computer program instructions may be installed in a computer or some other programmable data processing equipment, a series of operational steps is performed on the computer or some other programmable data processing equipment and creates computer executable processes, so that instructions to run the computer or some other programmable data processing equipment may provide steps for performing functions that are described in flowchart blocks.

Furthermore, each block may represent part of module, a segment or code including one or more executable instructions for executing a specific logic function. For example, two successively illustrated blocks may be actually performed at the same time or may be performed in reverse order depending on the corresponding function.

Now a detailed description will be given of a method for processing multiple requests using a Dataset Transfer Protocol (DTP) according to an embodiment of the present invention.

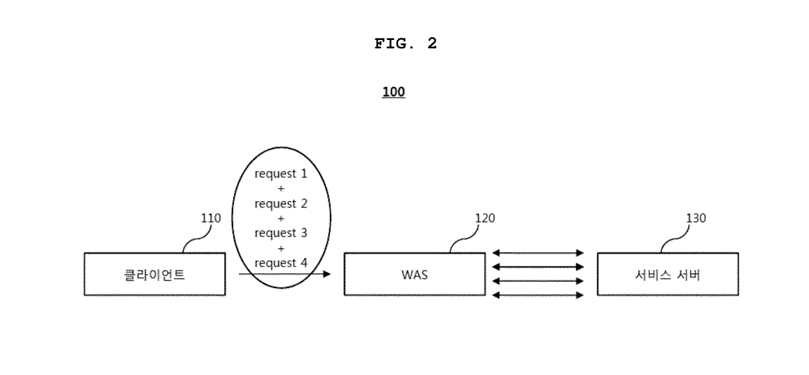

FIG. 2 illustrates a system configuration referred to for describing a method for processing multiple requests using a DTP according to an embodiment of the present invention.

Referring to FIG. 2, a system 100 may include a client 110, a Web application server 120, and a service server 130. The client 110 corresponds to a terminal that receives an on-line service. The WAS 120 functions as a gateway that receives a request from the client 110 and processes the request by communicating with the service server 130. The service server 130 receives a processing request from the WAS 120 by communicating with the WAS and returns a processing result to the WAS 120.

According to the method for processing multiple requests using a DTP according to the embodiment of the present invention as illustrated in FIG. 2, the client 110 transmits multiple processing request commands at one time by the DTP to the WAS 120 and receives the result of processing the multiple processing request commands from the WAS 120. In this manner, the multiple processing request commands may be transmitted through one connection session with the WAS 120.

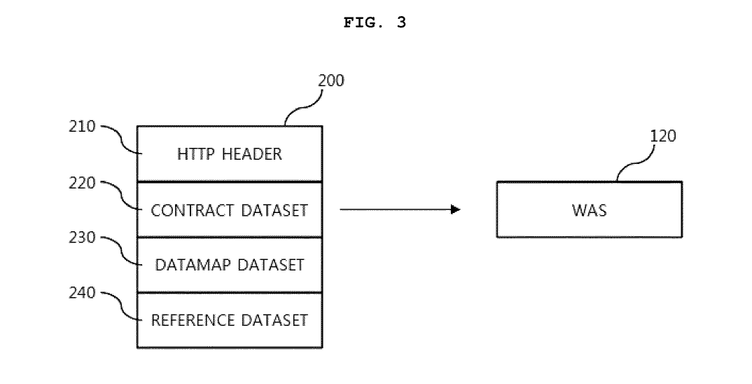

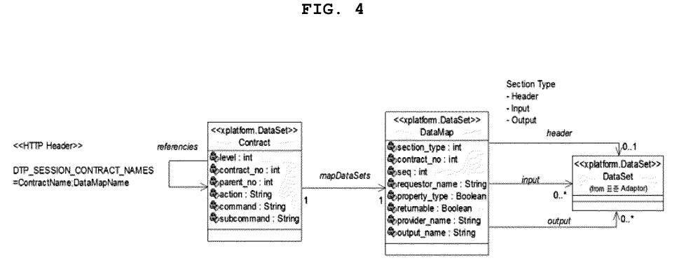

FIG. 3 illustrates a structure of the DTP in the method for processing multiple requests using a DTP according to the embodiment of the present invention and FIG. 4 illustrates information included in the DTP, which is represented as a function, in the method for processing multiple requests using a DTP according to the embodiment of the present invention.

Referring to FIG. 3, a DTP 200 may include a HyperText Transfer Protocol (HTTP) header 210, a contract dataset 220, a datamap dataset 230, and a reference dataset 240. The client 110 transmits the DTP 200 having this configuration to the WAS 120.

The DTP will be described in greater detail.

The contract dataset 220 may include information about a sequence number of a contract generated according to a processing request, information about a requested task, information about a level at which the contract is positioned in a tree structure, and information about a sequence number of a parent contract for the contract.

The sequence number of the contract included in the contract dataset 220 indicates the generation sequence of the contracts and may be expressed as a function such as contract_no( ). The information about the requested task specifies the type and option of a task to be performed upon request, expressed as a function such as action( ).

The level information specifies a level at which the contract is positioned in a tree structure, expressed as a function such as level( ). A plurality of contracts may be arranged hierarchically in a tree structure. The level information manages the parent or child role of the current contract with respect to another contract.

The information about the sequence number of the parent contract for the contract may be expressed as a function such as parent_no( ).

With the contract dataset 220, the current contract may be positioned as a parent or child in connection with another contract in a tree structure.

The datamap dataset 230 may include information about mapping between an input dataset and an output dataset regarding the contract. Specifically, the datamap dataset 230 may include information about a sequence number of a reference contract, information about a name of the reference dataset defined by the client 110, information about a name of a dataset mapped to the dataset with the name information in an called service, and information about a name of a dataset to store the result of the requested task.

The information about the sequence number of the reference contract indicates the sequence number of a contract that the datamap dataset 230 may refer to, expressed as contract_no( ). The datamap dataset 230 is mapped to the contract dataset 220 based on the sequence number information.

The reference dataset 240 is a dataset to be referred to during the requested task. The reference dataset 240 may include an input dataset to be referred to during the requested task or an output dataset with a result value to be returned upon completion of the requested task. In addition, the reference dataset 240 may include a header dataset. The header dataset provides context information about a restriction in the contract dataset or additional information required for service processing. While the contract dataset is fixed, the header dataset provides context information extendable according to a task.

To avoid the same name for different reference datasets, the client 110 defines a name for reference data without redundancy. That is, the client 110 assigns a name to a reference dataset. Information about the name of the reference dataset defined by the client 110 may be expressed as a function such as requestor_name( ).

A dataset set with the name information that the client 110 assigns to the reference data set may be processed with a different name in an called service. The datamap dataset 230 includes information about a name of the dataset that the called service maps to the name of the data set defined by the client 110. The name information about the dataset mapped in the called service may be expressed as a function such as provider_name( ).

A name of a dataset to store the result of the requested task may be stored, expressed as a function such as output_name( ). In the presence of the schema of a dataset which is set with the name of the dataset to store the result of the requested task, only information set for the dataset in the processing result is included in the dataset and data stored before an initial access for storing the processing result in the dataset is all deleted except for the schema.

The datamap dataset 230 may further include type information indicating the type of the reference dataset. The type information may be expressed as a function such as section_type( ). The type information may indicate at least one of a header dataset, an input dataset, and an output dataset related to a processing result.

The datamap dataset 230 may indicate a unique identification number set in the reference contract, expressed as a function such as seq( ). The datamap dataset 230 may indicate whether a dataset with name information defined by the client for the reference dataset has a data structure “name=value” or any other data structure, expressed as a function such as property_type( ). The datamap dataset 230 may indicate whether a selected dataset is to be included in result information, expressed as a function such as returnable( ).

The HTTP header 210 includes name information about the contract dataset and name information about the mapping information dataset. The contract dataset and the datamap dataset should be unique in the DTP.

Multiple processing request commands may be transmitted to the WAS 120 by a DTP including a plurality of HTTP headers 210, a plurality of contract datasets 220, a plurality of datamap datasets 230, and a plurality of reference datasets 240.

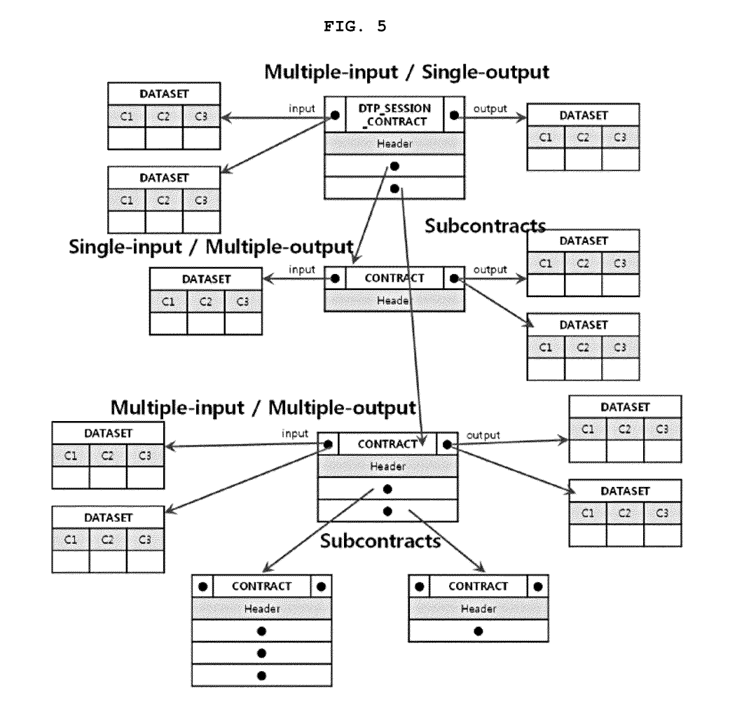

FIG. 5 illustrates an exemplary structure of the DTP in a method for processing multiple requests using a DTP according to the embodiment of the present invention.

Referring to FIG. 5, a contract dataset 220 may be connected to another contract as a child or a parent in a tree structure. A datamap dataset 230 mapped to each contract dataset 220 connects the contract dataset 220 to a reference dataset for performing a processing request command of the contract dataset 220. Contracts datasets 220 including a plurality of processing request commands, connected to one another in a tree structure, and datamap datasets 230 and reference datasets 240 which are mapped to the contract datasets 220 may be transmitted from the client 110 to the WAS 120 by a DTP.

As is apparent from the above description of the method for processing multiple requests using a DTP according to the embodiment of the present invention, multiple requests can be processed by one invocation. Therefore, the resource constraint and load of a client are reduced and a bandwidth loss of a communication network caused by redundant connections and redundant request packets can be decreased.

The method for processing multiple requests using a DTP according to the embodiment of the present invention may be written as a program that can be executed by a computer and may be implemented in a general-purpose digital computer that can execute the program using a computer-readable recording medium. Examples of the computer-readable recording medium include magnetic media such as a hard disk a floppy disk, and a magnetic tape, optical media such as a CD ROM and a DVD, magneto-optical media such as a floptical disk, and hardware devices specially configured to store and perform a program command, such as a ROM, a RAM, and a flash memory. The program command includes a premium language code executable in a computer by means of an interpreter as well as a mechanical code as written by a compiler.

Those skilled in the art will appreciate that the present invention may be carried out in other specific ways than those set forth herein without departing from the spirit and essential characteristics of the present invention. The above embodiments are therefore to be construed in all aspects as illustrative and not restrictive. The scope of the invention should be determined by the appended claims and their legal equivalents, not by the above description, and all changes coming within the meaning and equivalency range of the appended claims are intended to be embraced therein.

What is claimed is:

1. A method for processing multiple requests using a dataset transfer protocol, the method comprising:
generating a dataset transfer protocol and transmitting the dataset transfer protocol to a Web Application Server (WAS) by a client,
wherein the dataset transfer protocol includes:
at least one contract dataset including information about a sequence number of a contract generated according to a processing request and information about a requested task;
at least one reference dataset referred to for processing the processing request;
at least one datamap dataset including type information indicating a type of the reference dataset referred to in relation to the contract and mapping information about the reference dataset; and
at least one header including information about a name of the contract dataset and information about a name of the mapping information dataset.

2. The method according to claim 1, wherein the contract dataset further includes level information indicating a level at which the contract is positioned in a tree structure and information about a sequence number of a parent contract for the contract.

3. The method according to claim 1, wherein the datamap dataset includes information about a sequence number of a reference contract, information about a name of the reference dataset defined by the client, information about a name of a dataset mapped to a dataset corresponding to the name information about the reference dataset in an called service, and information about a name of a dataset to store a result of the requested task.

4. The method according to claim 1, wherein the reference dataset includes at least one of an input dataset, an output dataset, and a header dataset specifying additional information required for the processing request.

5. The method according to claim 4, wherein the type information indicates at least one of the input dataset, the output dataset, and the header dataset.

6. The method according to claim 1, wherein the header is a HyperText Transfer Protocol (HTTP) header.

7. A computer-readable recording medium for storing a program to perform the method according to claim 1.

8. A recording medium readable in a computer that stores a program to perform the method according to claim 1.

9. A client device configured to perform the method according to claim 1.
